(19) United States
(12) Patent Application Publication
(10) Pub. No.: US 2012/0113513 A1
(43) Pub. Date: May 10, 2012

(54) SELF-CLEANING OF OPTICAL SURFACES IN LOW-PRESSURE REACTIVE GAS ENVIRONMENTS IN ADVANCED OPTICAL SYSTEMS

(75) Inventors: Xiaoshi Zhang, Superior, CO (US); Henry C. Kapteyn, Boulder, CO (US)

(73) Assignee: The Regents of the University of Colorado, a body corporate, Denver, CO (US)

(21) Appl. No.: 13/279,257

(22) Filed: Oct. 22, 2011

Related U.S. Application Data
(60) Provisional application No. 61/405,677, filed on Oct. 22, 2010.

(51) Int. Cl. G02B 23/16

(52) U.S. Cl. 359/513

(57) ABSTRACT

Apparatus and methods for self-cleaning of optical elements in sealed environments over a wide range of operating optical frequencies prevent long-term power degradation by introducing low-pressure backfill of a reactive gas such as oxygen into a vacuum chamber containing the optical elements. The backfill pressure is preferably between 10⁻⁴ torr and 10 torr, and generally between 0.1 torr and 2 torr at room temperature. The vacuum chamber may be continuously evacuated and backfilled, or may be sealed after evacuation and backfill is performed.

### BACKGROUND OF THE INVENTION

1. Field of the Invention

The present invention relates to self-cleaning of optical elements in advanced optical and laser systems. In particular, the present invention relates to self-cleaning of optical elements in vacuum chambers accomplished by adding a reactive gas to the vacuum chamber.

2. Description of Related Art

Advanced optical and laser systems operating in the wavelength ranging from far infrared to extreme ultraviolet (EUV) are making increasing use of vacuum or sealed environments for part or even all of their optical components. For example, high average power laser systems make use of aggressively cooled laser media, where a laser crystal is placed in a vacuum cell and kept at low temperature (often cryogenic <150K) to increase the thermal conductivity, and thus decrease the laser-induced thermal lensing of the laser medium. Previous work with common inventors to the present application shows several embodiments of ultrashort pulse amplification in cryogenically cooled amplifiers. See architectures described in (S. Backus, et al., “High-efficiency, single-stage 7-kHz high-average-power ultrafast laser system,” Optics Letters, vol. 26, pp. 465-467, 2001; S. J. Backus, et al., and “Ultrashort pulse amplification in cryogenically cooled amplifiers” U.S. Pat. No. 6,804,287 (incorporated herein by reference). These configurations are very useful, but as average or peak power loads increase, power degradation becomes a problem due to deposition on optics.

Another example is the use of resonant buildup cavities for the generation of coherent light at new wavelengths, i.e. extreme ultraviolet (EUV) and infrared (which are strongly absorbed by the air and/or H₂O molecules) through nonlinear optical conversion. In this case, ultrashort light pulses are stacked-up in a low-loss cavity, and focused into a nonlinear medium within the cavity to a sufficiently high intensity to implement nonlinear techniques such as high-order harmonic generation, optical difference frequency generation, rectification or optical parametric oscillation. A third case is one of grating pulse compressors for TW ultrafast amplifiers, where the compression gratings must be kept in a vacuum to avoid nonlinear distortion of the high power ultrashort laser pulse as it propagates in the air and/or carbon deposition on the gratings. Furthermore, optical systems for the extreme-ultraviolet, including lithography, imaging and spectroscopy system, require vacuum because the light wavelengths of interest are strongly absorbed by the air through direct, single photon ionization.

These systems are extremely sensitive to contamination resulting in degraded transmission or reflection of the optics, often also leading to damage of optical coating/surfaces. Generally this is due to the fact that much of the residual gas inside a vacuum system consists of hydrocarbons, originating from either from the vacuum pumping system or from outgassing of components within the vacuum/sealed chamber. These hydrocarbons tend to deposit on the optical surfaces where the high-intensity beams are incident, resulting in coating of the optical surfaces. This phenomenon is well known in EUV and soft x-ray optical systems, where the propagating radiation has photon energy high enough to directly (i.e. single photon) ionize any residual atomic of molecular gas. And systems have been developed to clean the optics in these systems, for example using low-pressure RF-excited oxygen radicals or ions. These systems supply gas that can easily react with hydrocarbons to produce non-contaminating end products such as H₂O, CO and CO₂. However, since these systems are completely sealed from the environment, these active cleaning methods require unsealing the optical system, often interrupting operation, or the use of a dedicated and expensive cleaning system for the vacuum system. Previous work has also investigated the use of a continuous low-pressure H₂O/O₂/H₂ environment for self-cleaning of optics in vacuum EUV/x-ray lithography systems. (U.S. Pat. No. 6,664,554 B2) This work, however, specifies the use of “a metal disposed on the surface of the optic, wherein said metal protects the optic surface against oxidation.” Furthermore, reduction in practice in this work was limited to the use of EUV optical systems. In this case the ionizing radiation, EUV/x-ray, propagating in the optical system will lead to the direct (i.e. induced by a single photon) creation of oxygen/hydrogen ions or neutral radicals that can serve to scavenge carbon deposits from a multilayer reflective optical surface to produce non-contaminant CH₄, CO, CO₂ and other gas-phase molecules.

In contrast to the prior art of U.S. Pat. No. 6,664,554, a need remains for a self-cleaning system that does not require altering the design of the optics themselves by including an oxidation-resistant metal coating. The abovementioned patent states that the reason for contamination was that “EUV radiation is energetic enough to cause the decomposition of water molecules adsorbed on or proximate to a surface to produce hydrogen and reactive oxygen species that can attach, degrade, or otherwise contaminate optical surfaces.” Furthermore, a need remains in the art for self-cleaning system that operate in the visible/IR regions. Visible/IR light photons are not energetic enough to cause this decomposition.

The present invention originated from the observation of hydrocarbon contamination of optical components in a cryogenically cooled near-infrared femtosecond laser, where the laser medium was confined to a vacuum cryostat with entrance and exit windows. The power output was observed to degrade over a time of hours. In order to determine the cause of the power degradation, the inventors did various tests. They studied the pump mode on the laser crystal as a function of time by imaging the crystal on a CCD camera. By intentionally placing the pump beam focus behind the laser crystal, they found that the pump mode on the laser crystal became first smaller, then larger, and eventually turned into a donut-shaped mode (i.e. dimmed in the center) over an 8 hour period. This occurred even when the vacuum was ˜10⁻⁷ torr inside the cryostat containing the laser crystal. This test is consistent with a picture that some contaminant is trapped by or reacts with the pump laser beam, forming a coating on the entrance window of the chamber. The center of the laser beam, where the laser intensity is highest, accumulates contaminants rapidly, thus forming the thickest layer on the optics where the most intense portion of the beam passes. The resulting residual absorption caused by this layer likely creates a thermal gradient that results in a lensing effect from the entrance window, with its focal length decreasing over time, which can account for the pump laser mode variation with time.

### SUMMARY

It is an object of the present invention to provide apparatus and methods for self-cleaning of optical elements in sealed environments over a wide range of operating optical frequencies. The introduction of a low-pressure oxygen background into a vacuum chamber can be used to preclude deposition on optics in a vacuum system, in particular in the case of laser systems where light in the optical system is intense but is not predominantly EUV, and where no metal coating or other special preparation of the optics in the system is required. This oxygen backfill serves to keep optics clean even when the only light incident on an optical surface is IR/visible, and thus generally will not directly ionize hydrocarbons or the oxygen gas introduced into the chamber. The result is that a low-pressure oxygen backfill greatly extends the duration between physical or active-cleaning of the optics in optical systems. This is an extremely useful realization, especially for ultrafast optical systems that would otherwise simply be impractical for routine laboratory use.

The method of self-cleaning optical elements operating at a high average power in a vacuum chamber comprises the steps of arranging optical elements in a vacuum chamber, evacuating the chamber providing a backfill of a reactive gas to result in a selected backfill pressure in the chamber, providing a laser input beam to the optical elements and manipulating the laser beam with the optical elements to provide an output beam. For example, the reactive gas might be oxygen. Preferably the backfill pressure is between 10⁻⁴ torr and 10 torr. Generally it is between 0.1 torr and 2 torr at room temperature.

The vacuum chamber may house a variety of optical systems, including amplifiers, recirculating cavities, and compressors. The present invention is especially useful when the laser beam results in an average power of at least about 100 MW within a spot size of 5 mm or less, or an average power of at least about 10 W power in a 1 mm² spot, or greater than 1 kW cm⁻² average fluence.

In one embodiment, the vacuum chamber is sealed after evacuation and backfill, and is kept sealed while the optics manipulate the laser beam. The backfill apparatus may be detached from the vacuum chamber, as may the pump. In another embodiment, the system is allowed to operate for a while, and the chamber is evacuated again. In another embodiment, the chamber is continuously evacuated and backfilled while the system is operating.

The present invention is useful over a variety of optical frequencies, and particularly when the laser beam provides a beam in the IR to visible frequency range.

### BRIEF DESCRIPTION OF THE DRAWINGS

FIG. 1A (Prior Art) is a block diagram showing an example of a cryogenically cooled ultrafast laser amplifier system which experiences significant power degradation at high average or peak power loads. FIG. 1B is a cutaway schematic view of the cryostat in the system of FIG. 1A.

FIG. 2A is a block diagram showing an advanced optical system such as that of FIG. 1 with oxygen backfill apparatus according to the present invention. FIG. 2B is a block diagram similar to that of FIG. 2A wherein the advanced optical system is a recirculating cavity. FIG. 2C is a block diagram similar to that of FIG. 2A wherein the advanced optical system is a compressor.

FIG. 3 is a plot showing power variation over time for laser systems such as those shown in FIGS. 1A, 1B, and 2.

FIG. 4 is a plot similar to FIG. 3, where a 2 torr N₂ backfill was substituted for O₂ backfill in the vacuum cell.

### DETAILED DESCRIPTION OF THE PREFERRED EMBODIMENTS

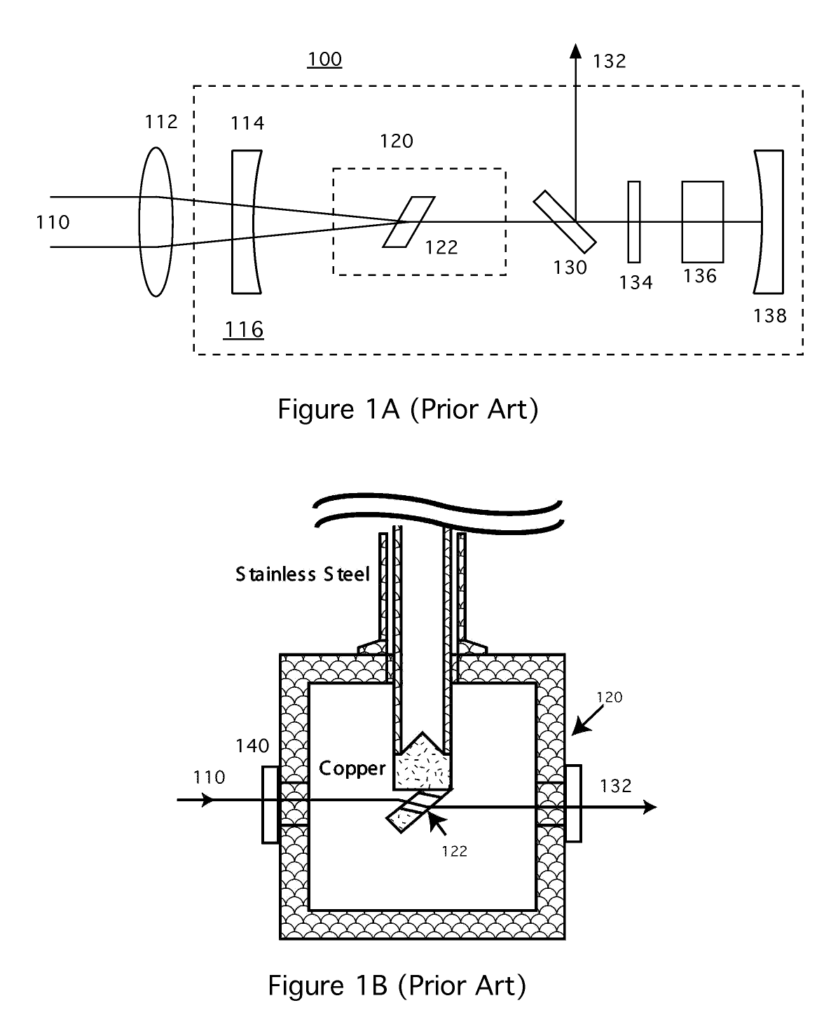

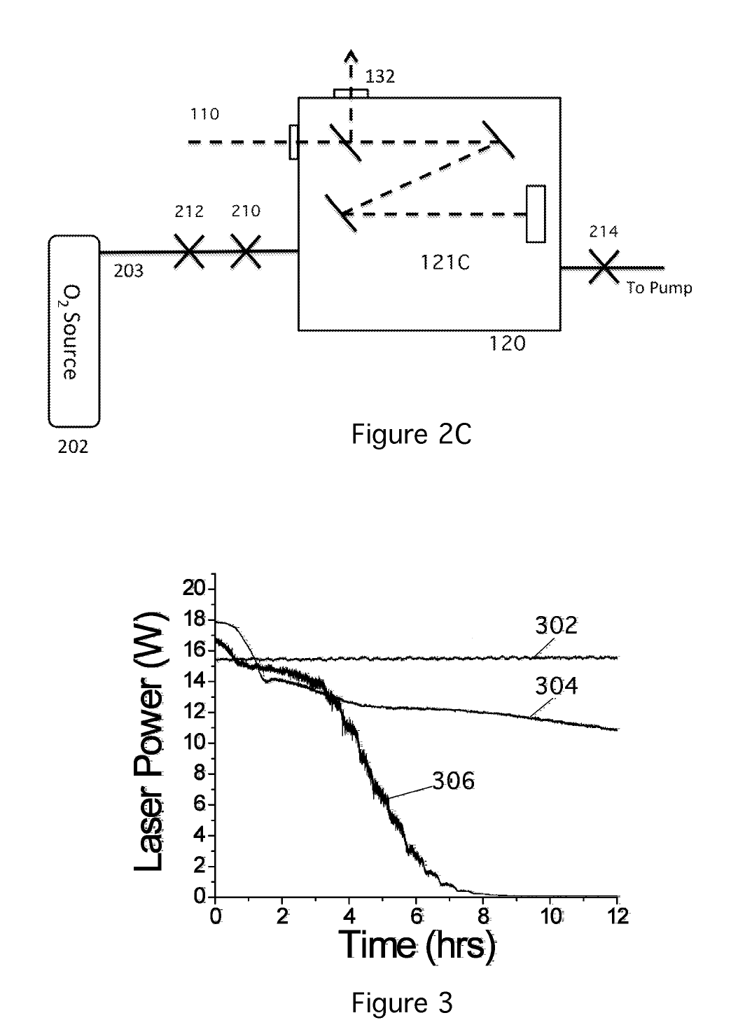

FIG. 1A (Prior art) is an example of a prior art cryogenically cooled ultrafast laser amplifier system which experiences significant power degradation at high average or peak power loads. FIG. 1B is a cutaway schematic view of the cryostat vacuum chamber 120 of the system of FIG. 1A. Other examples of prior art amplifier systems of this sort are shown and described in U.S. Pat. No. 6,804,287 (incorporated herein by reference), especially in FIGS. 3-6. Laser crystal 122 is housed in vacuum chamber 120 for cryogenic cooling. Various optical elements are housed in regenerative amplifier 116, in this case mirrors 114, 138, amplifier medium 122, thin film polarizer 130, wave plate 134, and Pockels cell 136. In this case, the regenerative amplifier configuration was used in conjunction with up to three high power (32 W each), high repetition rate (10-200 kHz) and single mode 532 nm pump lasers. The beam 110 from a pump laser was a near TEM₀₀ mode; i.e. a beam that focuses to the smallest diffraction-limited spot. The laser beam 110 was focused via lens 112 into a single spot on the cryogenically cooled ti:sapphire crystal 122. In this invention, we back-filled low pressure O2 gas into the vacuum chamber 122 to solve long-term power degradation issues in this regenerative amplifier system. Because of the highly focusable narrow focus TEM00 nature of the beam, the fluence on both the surface of crystal 122 and on the entrance and exit windows 140 of the cryostat was high enough to cause contamination on the crystal surface.

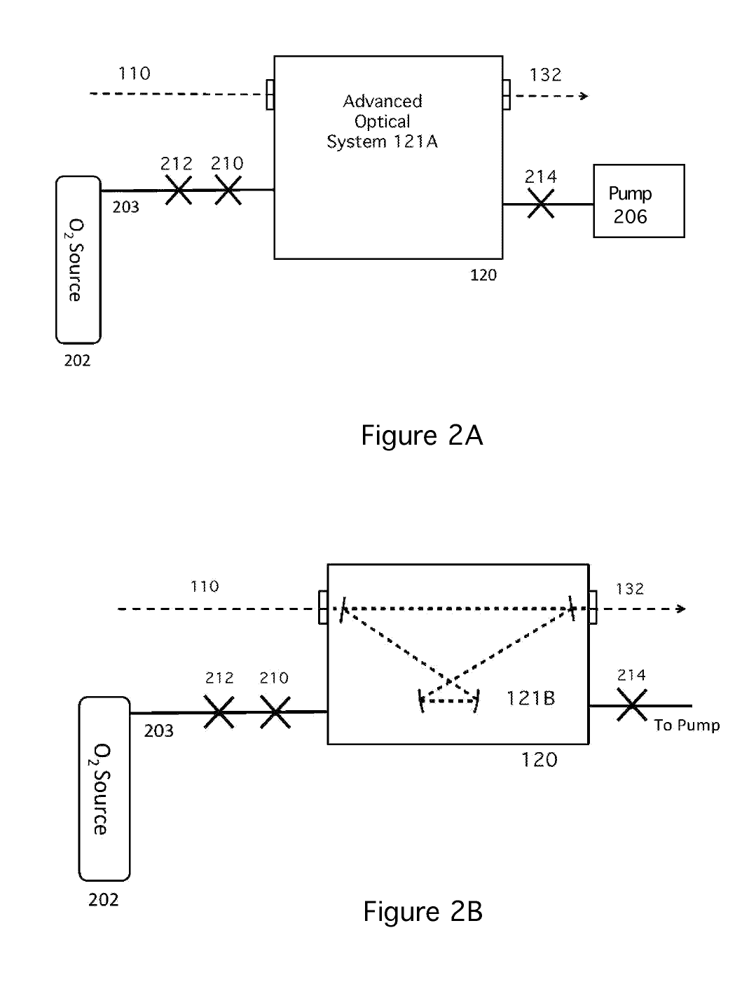

FIG. 2A is a block diagram showing an advanced optical system operating in a sealed environment such as vacuum chamber 120. This system is similar to that of FIG. 1 except that after the vacuum is formed by evacuating most of the air from chamber 120 via pump 216, a low pressure oxygen backfill 202 is added to chamber 120 with oxygen backfill apparatus 203, 212, 210. The advanced optical system could be a laser amplifier, frequency conversion system, optical laser pulse compressor or other optical systems that is sensitive to contaminations to the optical surfaces. Therefore, the specific optical elements housed in vacuum chamber 116 are not shown. They could comprise the elements in FIG. 1, the systems described in U.S. Pat. No. 6,804,287, or other setups. In the following discussion, the advanced optical system 121A is assumed to be an amplifier similar to that shown in FIGS. 1A and 1B.

Pumping causes a vacuum to form in vacuum chamber 120. After the vacuum is created, a small amount of oxygen/or other reactive species 203 is inserted into vacuum chamber 120. In a first embodiment, valves 210 and 214 are closed and chamber 210 is sealed for some period of time while in use. The oxygen source may be disconnected from vacuum chamber 120 via connector 212, if desired. Pump 206 may also be disconnected. Generally, an input pump beam 110 is provided to the vacuum chamber 120. The optics within vacuum chamber 120 amplify pump beam 110 and provide an amplified output beam 132.

In a second embodiment, chamber 120 is evacuated, the oxygen backfill in inserted, and the optical system is run for a period of time. Then, chamber 120 is re-evacuated and sealed. Tests have shown that in some cases the backfilled O2 gas can be evacuated from the chamber after an extended period of operation, once all contaminants have been consumed by the backfilled gas. A period of several weeks of operation has proved to be sufficient in one test.

In a third embodiment, pumping is continuous, and oxygen 202 is added continuously as well, at such a rate that the desired pressure is maintained. In this case, valves 210, 214 and are not closed and may not need to be present.

The oxygen backfill of the present invention is most useful in systems wherein the power level is high enough to cause contamination, for example peak powers exceeding 100 MW for an amplifier, or over 5 mJ pulse energy for a compressor, over a spot size of 5 mm or less. A wide range of oxygen backfill pressures provides a benefit, from >10 torr down to as low as 10⁻⁴ torr. Pressures between 0.1 torr and 2 torr have proven to work especially well. In a cryogenic chamber, the initial pressure of (for example) 2 torr is reduced to around 10⁻² torr because of gas condensation on the low temperature components. This still works well, because as oxygen is used up in the system, the remaining oxygen becomes available.

FIG. 2B is a block diagram similar to that of FIG. 2A wherein the advanced optical system 121B is a recirculating cavity. FIG. 2C is a block diagram similar to that of FIG. 2A wherein the advanced optical system is a compressor. The elements are shown schematically rather than in detail, as various configurations may be used. All of the optical elements within the vacuum chamber benefit from the oxygen backfill.

FIG. 3 is a plot showing power variation over time for laser systems such as those shown in FIGS. 1A and 1B (Prior art) and FIG. 2A. These tests were done using a prior art ultrafast cryogenically cooled ti:sapphire laser-amplifier system shown schematically in FIGS. 1A and 1B and the same amplifier system with the addition of the self-cleaning system according to the present invention, as shown in FIG. 2A.

Prior art laser system 100 suffered from continuous power degradation, caused by contamination of crystal 122 and the entrance windows 140, over the course of several hours following turn-on of laser 110. The laser power versus time is shown as curve 306 in FIG. 3.

Then, the inventors actively cleaned the vacuum and optical components in the cryostat using a commercial RF exited O₂ plasma cleaner, and then did a similar test. This RF-O₂ cleaning reduced the cryostat background pressure to ˜10⁻⁹ torr. The power drop from the laser was slower but still clearly observed, as shown in curve 304 in FIG. 3. This indicates that contamination is very difficult to avoid, even within an ultra-high vacuum environment and after careful active cleaning of the cryostat.

It should be noted that the inventors found that the observed time-dependent variation in the pump mode focused onto the crystal is not specifically pulse energy dependent. They did tests at different repetition rates, but the same average power—the time-scale of the variations shown in FIG. 3 did not change. On the other hand, lowering the average power of the pump laser overall did slow the power degradation.

The observations described above contrast with prior work where the inventors did not observe significant degradation over time. In that system a “multimode” pump laser at lower power and repetition rate was used. A multimode beam is not as focusable as TEM₀₀, so that to focus it to a given spot size on the laser crystal, it was necessary to focus the pump laser beam with high F #; i.e. using a beam that focuses tightly from a very large initial spot size. In this case; i.e. in the prior system, the pump beam size on the entrance window of the cryostat was quite large (i.e. ˜1 cm diameter or more).

In the TEM₀₀ test, the very focusable, single-mode characteristic of the pump beams meant that the pump beams entering the cryostat were of very small diameter (e.g. about 5 mm or less). The higher fluence on the entrance windows resulted in laser-assisted hydrocarbon deposition, photochemical processes, or both, that deposited a thin nonuniform film onto the entrance window. Test indicate that deposition depends on the average intensity of the beam.

In backfilling with oxygen, there is a tradeoff in that the insulation characteristics of the cryostat are compromised. However, the inventors found a sufficient range of pressures where buildup of a film could be prevented with minimal loss in cooling capacity of the cryostat. FIG. 3, curve 302 shows a 12-hour run of the laser amplifier system with an oxygen backfill of 2 torr (at room temperature), showing negligible degradation in power output from the laser over this 12 hour period. The oxygen backfill pressure of ˜2 torr did not result in significant heat conduction, and the exterior of the cryostat chamber remained at room temperature (21° C.). When the cryostat reaches its base temperature after turn-on, the actual pressure inside the cryostat was reduced to <10⁻² torr due to condensation and adsorption of oxygen onto the laser crystal and mount at low temperature.

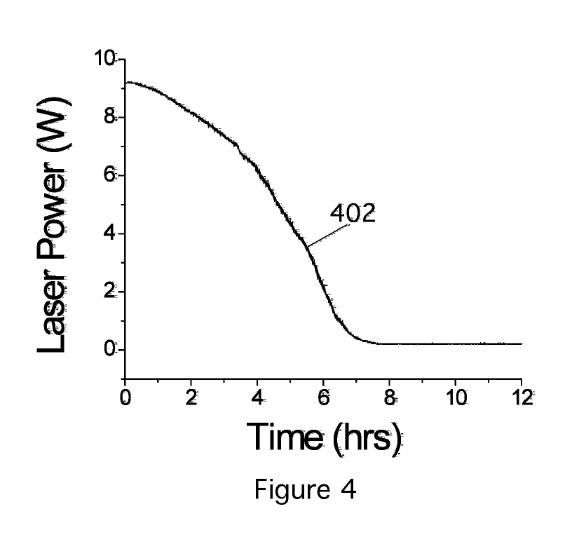

Control tests were also performed to see to what extent a reactive gas such as oxygen was necessary to keep the optics clean. FIG. 4 shows runs using 2 torr nitrogen gas (at room temperature, also falling to <10⁻² torr at cryogenic temperature). The nitrogen is not as chemically reactive to the likely contaminants (i.e. hydrocarbons). In this case curve 402 shows there is a power degradation, indicating that the reactivity of oxygen was critical for this cleaning effect to occur. Other reactive gasses such as chlorine, hydrogen, fluorine, and ammonia are also likely to work, but clearly the effect is not simply one of keeping a low gas pressure in the vacuum cell. It is likely that a reactive gas such as oxygen mixed with a non reactive gas such as nitrogen would still accomplish cleaning since the nitrogen would not interfere with the operation of the oxygen. However, contaminants should be avoided. While the exemplary preferred embodiments of the present invention are described herein with particularity, those skilled in the art will appreciate various changes, additions, and applications other than those specifically mentioned, which are within the spirit of this invention.

What is claimed is:

1. The method of self-cleaning optical elements operating at a high average power in a vacuum chamber comprising the steps of:
(a) arranging optical elements in a vacuum chamber;
(b) evacuating the chamber;
(c) providing a backfill of a reactive gas to result in a selected backfill pressure in the chamber;
(d) providing a laser input beam to the optical elements;
(e) manipulating the laser beam with the optical elements to provide an output beam.

2. The method of claim 1 wherein the providing step provides an oxygen backfill.

3. The apparatus of claim 1 wherein the backfill providing step results in a backfill pressure of between 10⁻⁴ torr and 10 torr.

4. The apparatus of claim 3 wherein the backfill providing step results in a backfill pressure of between 0.1 torr and 2 torr at room temperature.

5. The method of claim 1 wherein the step of providing a laser beam results in an average power of at least about 100 MW within a spot size of 5 mm or less.

6. The method of claim 1 wherein the step of providing a laser beam results in an average power of at least about 10 W power in a 1 mm² spot, or greater than 1 kW cm⁻² average fluence.

7. The method of claim 1 further comprising the steps of sealing the vacuum chamber and keeping it sealed while manipulating the laser beam.

8. The method of claim 7 further including the step of evacuating the chamber again after manipulating the laser beam.

9. The method of claim 1 wherein step (b) continuously evacuates the chamber while the laser beam is manipulated, and wherein step (c) continuously provides a backfill while the laser beam is manipulated.

10. The method of claim 1 wherein the step of providing a laser beam provides a beam in the IR to visible frequency range.

11. Apparatus for self-cleaning optical elements in a high-average-power optical system disposed in a vacuum chamber comprising:
a vacuum chamber containing optical elements constructed and arranged to manipulate an input laser beam and provide a manipulated output beam;
pump apparatus for allowing the vacuum chamber to be evacuated;
backfill apparatus connectable to the vacuum chamber for inserting a reactive gas into the sealed chamber to form a selected backfill pressure.

12. The apparatus of claim 1 wherein the backfill device is an oxygen backfill device.

13. The apparatus of claim 2 wherein the backfill pressure is between 10⁻⁴ torr and 10 torr.

14. The apparatus of claim 3 wherein the backfill pressure is between 0.1 torr and 2 torr at room temperature.

15. The apparatus of claim 1 wherein further comprising optical elements constructed and arrange to generate a spot size of 5 mm or less at an average power of at least about 100 MW.

16. The apparatus of claim 1 wherein further comprising optical elements constructed and arrange to generate a spot size of at least about 10 W power in a 1 mm² spot, or greater than 1 kW cm⁻² average fluence.

17. The apparatus of claim 1 wherein the optical elements within the vacuum chamber form an amplifier.

18. The apparatus of claim 1 wherein the optical elements within the vacuum chamber form a recirculating cavity.

19. The apparatus of claim 1 wherein the optical elements within the vacuum chamber form a compressor.

20. The apparatus of claim 1 wherein the backfill device is detachable from the vacuum chamber.
